(19) United States
(12) Patent Application Publication
(10) Pub. No.: US 2022/0286006 A1
(43) Pub. Date: Sep. 8, 2022

(54) MOTOR

(71) Applicant: NIDEC CORPORATION, Kyoto (JP)

(72) Inventors: Yuki Ishikawa, Kyoto (JP); Hironobu Kumagai, Kyoto (JP)

(21) Appl. No.: 17/685,266

(22) Filed: Mar. 2, 2022

(30) Foreign Application Priority Data
Mar. 8, 2021 (JP) 2021-036665

(51) Int. Cl. H02K 3/28; H02K 3/12; H02K 15/04

(52) U.S. Cl. CPC H02K 3/28; H02K 3/12; H02K 15/0428; H02K 2203/09

(57) ABSTRACT

A motor includes a rotor and a stator. The stator includes a stator core with slots, and conductor connection bodies connected in series and inserted into the slots. A plurality of straight portions of the conductor connection bodies include a first straight portion connected to a crossing portion and a second straight portion that is connected to one end of the folded portion and disposed in an innermost layer in the slot. In the slot, a distance between the second straight portion and the first straight portion located outside the second straight portion is larger than a distance between the first straight portions, and a protrusion direction in the radial direction of the folded portion with respect to the second straight portion and a protrusion direction in the radial direction of the crossing portion with respect to the first straight portion are different from each other.

### CROSS-REFERENCE TO RELATED APPLICATIONS

The present invention claims priority under 35 U.S.C. § 119 to Japanese Patent Application No. 2021-036665 filed on Mar. 8, 2021, the entire content of which is incorporated herein by reference.

### FIELD OF THE INVENTION

The present invention relates to a motor.

### BACKGROUND

In a motor for an electric vehicle, distributed winding is adopted for the purpose of reducing vibration and noise. There is conventionally known a wave-wound stator using a plurality of segment coils for the purpose of improving efficiency of the motor.

A long arrangement path of a conductor cannot be secured when wave winding of a conventional structure is performed. On the other hand, a folded portion is provided in the arrangement path of the wave-wound conductor, and the conductor is wave-wound in an opposite direction with the folded portion interposed therebetween, thereby lengthening the arrangement path of the conductor. However, a segment coil is non-circular and is significantly less flexible than a conductor using a general round wire. That is, because a shape of the folded portion is significantly different from that of the segment coil other than the folded portion, the segment coil of the folded portion has a large axial dimension in order to avoid other segment coils. Consequently, there is a problem in that the axial dimension of the stator is increased.

### SUMMARY

In one aspect of the present invention, an exemplary motor includes a rotor that is rotatable about a center axis line and a stator that is disposed on a radial outside of the rotor. The stator includes a stator core in which a plurality of slots standing in a circumferential direction are provided and a plurality of conductor connection bodies in which a plurality of conductors are connected in series, the plurality of conductor being inserted into the plurality of slots. Each of the conductor connection bodies includes: a first end located on an outermost circumference in a radial direction; a first portion that is wave-wound from the first end to the other side in the circumferential direction; a folded portion that is located on an innermost circumference in the radial direction and on one side in the axial direction of the stator core and connected to an end portion on the other side in the circumferential direction of the first portion; a second portion that is wave-wound from the folded portion to one side in the circumferential direction; and a second end that is located on the outermost circumference in the radial direction and connected to an end portion on one side in the circumferential direction of the second portion. Each of the first portion and the second portion includes: a plurality of straight portions that extend along the axial direction and are located in the slot; and a crossing portion that connects the straight portions to each other on one side in the axial direction of the stator core. The following expressions hold,

LS=LC×(N+n),0<n≤1,

where, a radial dimension of the slot is LS, a radial dimension of a section of the straight portion disposed in the slot is LC, and a number of the straight portions standing in the radial direction in one slot is N, and n is a constant. The plurality of straight portions include: a first straight portion connected to the crossing portion: and a second straight portion that is connected to an end of the folded portion and disposed in an innermost layer in the slot. In the slot, a distance between the second straight portion and the first straight portion located outside the second straight portion is larger than a distance between the first straight portions, and a protrusion direction in the radial direction of the folded portion with respect to the second straight portion and a protrusion direction in the radial direction of the crossing portion with respect to the first straight portion are different from each other.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a schematic sectional view illustrating a motor according to an embodiment;

FIG. 2 is a sectional view illustrating the motor taken along a line II-II of FIG. 1;

FIG. 3 is a schematic diagram illustrating a circuit configured by a winding portion and a bus bar unit of the embodiment;

FIG. 4 is a schematic diagram illustrating a winding configuration of a conductor connection body of the embodiment;

FIG. 5 is a plan view illustrating a part of a stator of the embodiment;

FIG. 6 is a sectional view illustrating a part of the stator of the embodiment;

FIG. 7 is a sectional view illustrating a part of the stator of the embodiment;

FIG. 8 is a sectional view illustrating a part of the stator of the embodiment;

FIG. 9 is an enlarged sectional view illustrating a slot of the stator of the embodiment;

FIG. 10 is a sectional view illustrating the stator taken along a line X-X of FIG. 6;

FIG. 11 is a sectional view illustrating the stator taken along a line XI-XI of FIG. 6;

FIG. 12 is a sectional view illustrating the stator taken along a line XII-XII of FIG. 6;

FIG. 13 is a sectional view illustrating a lower end portion of the stator taken along the line XI-XI of FIG. 6;

FIG. 14 is a schematic diagram illustrating a first folded portion and a second folded portion of the embodiment; and

FIG. 15 is a schematic diagram illustrating a first folded portion and a second folded portion according to a comparative embodiment.

### DETAILED DESCRIPTION

A Z-axis direction appropriately illustrated in each drawing is a vertical direction in which a positive side is an “upper side” and a negative side is a “lower side”. A center axis line J appropriately illustrated in each drawing is a virtual line that is parallel to the Z-axis direction and extends in the vertical direction. In the following description, an axial direction of the center axis line J, namely, the direction parallel to the vertical direction is simply referred to as an “axial direction”, the upper side is referred to as a “one side in the axial direction”, and the lower side is referred to as “the other side in the axial direction”. Sometimes a radial direction about the center axis line J is simply referred to as a “radial direction”. Furthermore, sometimes the circumferential direction centered on the center axis line J is simply referred to as the “circumferential direction”, a clockwise direction when viewed from above is referred to as “one side in the circumferential direction”, and a counterclockwise direction when viewed from above is referred to as “the other side in the circumferential direction”.

The vertical direction, the upper side, and the lower side are merely names for describing an arrangement relationship between respective units, and an actual arrangement relationship and the like may be other than the arrangement relationship indicated by these names. Furthermore, the directions described as one side in the axial direction and the other side in the axial direction can reproduce an effect of the embodiment even when they are replaced with each other. Similarly, the directions described as one side in the circumferential direction θ1 and the other side in the circumferential direction θ2 can reproduce the effect of the embodiment even when they are replaced with each other.

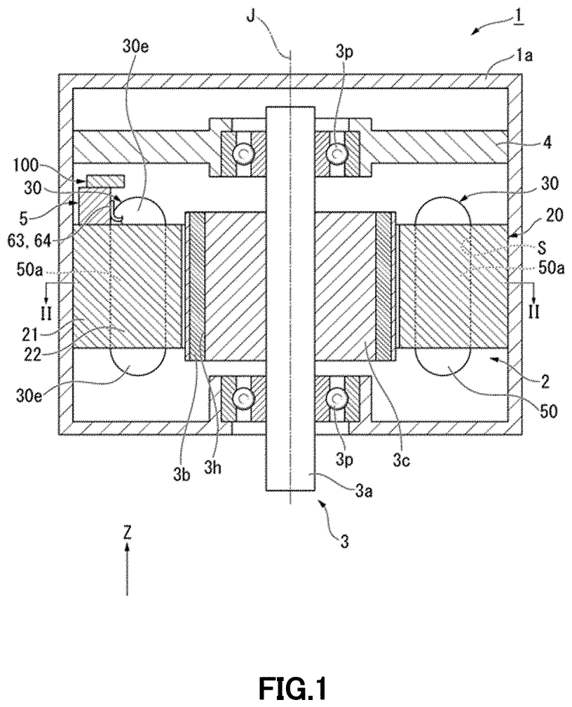

FIG. 1 is a schematic sectional view illustrating a motor 1 according to an embodiment.

The motor 1 of the embodiment is an inner-rotor motor. Furthermore, the motor 1 of the embodiment is a three-phase AC motor. The center of the motor 1 is the center axis line J.

The motor 1 includes a rotor 3, a stator 2, a bus bar unit 5, a connection bus bar unit 100, a bearing holder 4, and a housing 1a that accommodates them. The bus bar unit 5 is arranged above the stator 2. The connection bus bar unit 100 is further arranged above the bus bar unit 5. The bus bar unit 5 is connected to the stator 2. Furthermore, the connection bus bar unit 100 is connected to the bus bar unit 5 and an inverter (not illustrated).

The rotor 3 is rotatable about the center axis line J. The rotor 3 is arranged on the radially inside of the annular stator 2. That is, the rotor 3 is opposed to the stator 2 in the radial direction. The rotor 3 includes a shaft 3a, a rotor magnet 3b, and a rotor core 3c.

The shaft 3a extends in an axial direction along a center axis line J. The shaft 3a has a columnar shape centered on the center axis line J and extending in the axial direction. The shaft 3a is supported by two bearings 3p so as to be rotatable about the center axis line J.

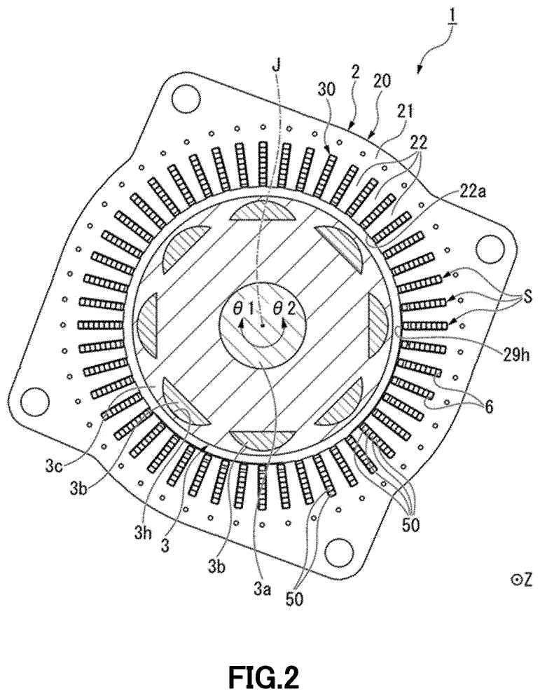

FIG. 2 is a sectional view illustrating the motor 1 taken along a line II-II of FIG. 1.

The rotor core 3c is configured by stacking magnetic steel sheets. The rotor core 3c has a cylindrical shape extending in the axial direction. An inner peripheral surface of the rotor core 3c is fixed to an outer peripheral surface of the shaft 3a. A holding hole 3h into which the rotor magnet 3b is inserted and fixed is made in the rotor core 3c.

The rotor magnet 3b is opposed to the stator 2 in the radial direction. The rotor magnet 3b is held while embedded in the rotor core 3c. The rotor magnet 3b of the embodiment has eight poles. A number of poles of the rotor 3 is not limited to the embodiment. Furthermore, the rotor magnet 3b may be a magnet of another form such as an annular ring magnet.

The stator 2 is arranged to the rotor 3 in the radial direction with a gap interposed therebetween. In the embodiment, the stator 2 is arranged on the radially outside of the rotor 3. The stator 2 includes a stator core 20, a winding portion 30, and a plurality of insulating papers 6.

The stator core 20 has the annular shape centered on the center axis line J. The stator core 20 consists of electromagnetic steel sheets stacked along the axial direction. The stator core 20 includes a core back 21 having an annular shape centered on the center axis line J and a plurality of teeth 22 extending radially inward from the core back 21.

The plurality of teeth 22 are arranged at regular intervals in the circumferential direction. An umbrella 22a is provided at a tip portion on the inside in the radial direction of the teeth 22. The umbrella 22a projects on both sides in the circumferential direction with respect to the teeth 22. That is, a dimension in the circumferential direction of the umbrella 22a is larger than a dimension in the circumferential direction of the teeth 22. The surface of the umbrella 22a facing inward in the radial direction is opposite to the outer peripheral surface of the rotor 3 in the radial direction with a gap interposed therebetween.

The winding portion 30 is mounted on the teeth 22. A slot S is provided between the teeth 22 adjacent to each other in the circumferential direction. That is, a plurality of slots S arranged in the circumferential direction are provided in the stator core 20.

A conductor 50 of the winding portion 30 is accommodated in the slot S. The insulating paper 6 is arranged one by one in the slot S. The insulating paper 6 secures insulation between the winding portion 30 and the stator core 20 in the slot S.

Eight layers arranged in the radial direction are provided in one slot S. In one slot, one conductor 50 is placed on each layer. In the slot S, eight conductors 50 are arranged in a row along the radial direction.

The slot S includes an opening 29h that is open radially inward. The opening 29h is located between the umbrellas 22a located at the tips of the adjacent teeth 22. A width dimension along the circumferential direction of the opening 29h is smaller than the dimension along the circumferential direction of the conductor 50. For this reason, the conductor 50 is difficult to pass through the opening 29h, and the conductor 50 is prevented from being separated from the stator core 20.

In the embodiment, the stator core 20 has 48 teeth 22. That is, the stator 2 of the embodiment has 48 slots. The number of slots of the stator 2 is appropriately set according to the number of poles of the rotor magnet 3b and a method for winding the winding portion 30.

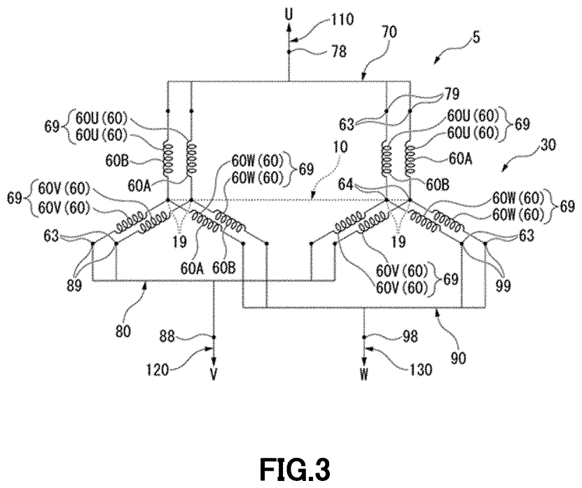

FIG. 3 is a schematic diagram illustrating a circuit configured by the winding portion 30 and the bus bar unit 5 of the embodiment.

The winding portion 30 of the embodiment includes a plurality of (12 in the embodiment) conductor connection bodies 60 to configure a segment coil. The 12 conductor connection bodies 60 are classified into four U-phase conductor connection bodies 60U, four V-phase conductor connection bodies 60V, and four W-phase conductor connection bodies 60W.

Furthermore, although described in detail later, the bus bar unit 5 includes three phase bus bars 70, 80, 90 and one neutral point bus bar 10. The three phase bus bars 70, 80, 90 are classified into a first-phase bus bar 70, a second-phase bus bar 80, and a third-phase bus bar 90.

The U-phase conductor connection body 60U, the V-phase conductor connection body 60V, and the W-phase conductor connection body 60W are Y-connected by the neutral point bus bar 10 and the phase bus bars 70, 80, 90. In the embodiment, four Y-connections corresponding to the four conductor connection bodies 60 of each phase are configured, and the Y-connections are connected in parallel. That is, the winding portion 30 is 4Y-connected by the bus bar unit 5.

In the embodiment, the case where the winding portion 30 includes four conductor connection bodies 60 having the same phase has been described. However, when the winding portion 30 includes at least two conductor connection bodies 60, and when these conductor connection bodies 60 configure a connection body pair 69 passing through the adjacent slots S in the circumferential direction, the winding configuration similar to that of the embodiment can be obtained. Accordingly, the plurality of conductor connection bodies 60 need only have Y-connections of 2×M with M as a natural number (M=2 in the embodiment).

The conductor connection body 60 includes a first end 63 and a second end 64. The first end 63 and the second end 64 are provided at one end and the other end of the conductor connection body 60, respectively. The conductor connection body 60 is mounted on the stator core 20 between the first end 63 and the second end 64 to configure a coil of each phase. The conductor connection body 60 is connected to the bus bar unit 5 in the first end 63 and the second end 64.

The second ends 64 of the four U-phase conductor connection bodies 60U, the four V-phase conductor connection bodies 60V, and the four W-phase conductor connection bodies 60W are connected to one neutral point bus bar 10. Thus, the second end 64 of the 12 conductor connection bodies 60 becomes the same potential and configures a neutral point. That is, the neutral point bus bar 10 configures the neutral point of the three-phase circuit.

The first ends 63 of the four U-phase conductor connection bodies 60U are connected to the first-phase bus bar 70. The first ends 63 of the four V-phase conductor connection bodies 60V are connected to the second-phase bus bar 80. The first ends 63 of the four W-phase conductor connection bodies 60W are connected to the third-phase bus bar 90. Alternating currents in which the phase is deviated for each 120° are passed through the phase bus bars 70, 80, 90.

Two of the four conductor connection bodies 60 having the same phase pass through the adjacent slots S and are mounted on the stator core 20. In the present specification, two conductor connection bodies 60 passing through the adjacent slots S are referred to as the connection body pair 69. Furthermore, in the following description, when two conductor connection bodies 60 forming the connection body pair 69 are distinguished from each other, one is referred to as a first conductor connection body 60A and the other is referred to as a second conductor connection body 60B.

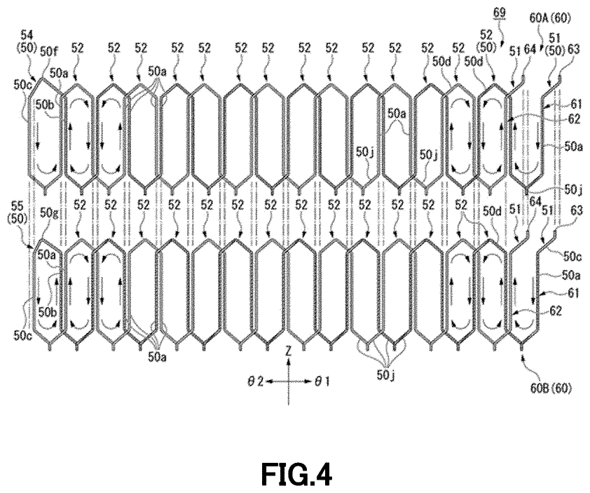

FIG. 4 is a schematic diagram illustrating a winding configuration of two conductor connection bodies 60 forming the connection body pair 69.

As illustrated in FIG. 4, the conductor connection body 60 is configured by connecting the plurality of conductors 50 in series. Each conductor 50 is configured by bending a flat wire. Accordingly, a space factor of the conductor 50 in the slot S can be improved as compared with the case of using a round wire. In the present specification, the “flat wire” is a wire rod having a quadrangular sectional shape or a substantially quadrangular sectional shape. In the present specification, the term “substantially square shape” includes a square shape with rounded corners. Although not illustrated, the conductor 50 in the embodiment has an enamel coating on the surface.

The plurality of conductors 50 configuring the conductor connection body 60 are classified into an end conductor 51, a hairpin conductor 52, a first folded conductor 54, and a second folded conductor 55.

Each of the various conductors 50 includes at least straight portions 50a, 50b, 50c extending linearly along the axial direction (Z-direction) and a connection portion 50j located at an end portion of the lower side (the other side in the axial direction). The straight portions 50a, 50b, 50c pass through the slot S. That is, the conductor connection body 60 is accommodated in the slot S at the straight portions 50a, 50b, 50c. The conductor connection body 60 extends above and below the stator core 20 in regions other than the straight portions 50a, 50b, 50c. The portions extending from the upper side and the lower side of the stator core 20 configure a coil end 30e (see FIG. 1) of the stator core 20.

The straight portion 50a, 50b, 50c is classified into a first straight portion 50a, a second straight portion 50b, and a third straight portion 50c. The first straight portion 50a is a straight portion connected to a crossing portion 50d or the ends 63, 64. The second straight portion 50b and the third straight portion 50c are straight portions connected to one end or the other end of the folded portions 50f, 50g.

A connection portion 50j is connected to a connection portion 50j of another conductor 50. The connection portions 50j of the pair of conductors 50 are joined to each other by joining means such as welding. The connection portion 50j is bent in the circumferential direction after the conductor 50 is mounted on the stator core 20, and the connection portion 50j is welded to the connection portion 50j of another conductor 50. In the conductor 50 before mounting on the stator core 20, the connection portion 50j has a straight line continuous to the straight portions 50a, 50b, 50c. The conductor 50 is attached to the stator core 20 by inserting the connection portion 50j and the straight portions 50a, 50b, 50c into the slot S from the upper side (one side in the axial direction) of the stator core 20. The connection portion 50j is bent in the circumferential direction and welded to another connection portion 50j, so that the conductor 50 is prevented from being axially detached from the stator core 20.

The plurality of conductors 50 are inserted into the slot S of the stator core 20 from the upper side and joined on the lower side, so that the stator 2 of the embodiment can be assembled. Consequently, a complicated assembly process is not required, but an assembly process can be simplified.

Various conductors 50 will be described below.

The end conductor 51 includes each one of the ends 63, 64, one straight portion 50a, and one connection portion 50j. The ends 63, 64 are located at the upper end portion of the end conductor 51. The ends 63, 64 are bent in the circumferential direction with respect to the straight portion 50a. In the end conductor 51, the ends 63, 64 and the connection portion 50j extend in the direction opposite to the circumferential direction with respect to the straight portion 50a. In the end conductor 51, the ends 63, 64 extend from the upper end of the straight portion 50a to one side in the circumferential direction θ1, and the connection portion 50j extends from the lower end of the straight portion 50a to the other side in the circumferential direction θ2.

One of the neutral point bus bar 10, the first-phase bus bar 70, the second-phase bus bar 80, and the third-phase bus bar 90 is connected to the ends 63, 64. The two ends 63, 64 are provided at both end portions of the conductor connection body 60, respectively. In the two ends 63, 64, one is the first end 63 and the other is the second end 64.

The hairpin conductor 52 includes two straight portions 50a, two connection portions 50j, and one crossing portion 50d. The crossing portion 50d is arranged at the upper end portion of the hairpin conductor 52. The crossing portion 50d passes two straight portions 50a to each other. That is, in the hairpin conductor 52, two straight portions 50a are connected to each other through the crossing portion 50d. In the hairpin conductor 52, two connection portions 50j are connected to the lower ends of different straight portions 50a. The plurality of crossing portions 50d project from the upper end surface (one side in the axial direction) of the stator core 20.

In the hairpin conductor 52, two straight portions 50a are lined up with the number of slots per pole s. At this point, the number of slots per pole s means the number of slots S of the stator 2 arranged between magnetic poles of the rotor 3 in the combination of the rotor 3 and the stator 2. The number of slots per pole s is calculated by (the total number of slots in the stator 2)/(the number of magnetic poles in the rotor 3). In the embodiment, the number of magnetic poles of the rotor 3 is 8, and the number of slots of the stator 2 is 48, so that the number of slots per pole s is 6. In the hairpin conductor 52, the two straight portions 50a are separated from each other by six slots in the circumferential direction.

In the hairpin conductor 52, two connection portions 50j are bent in opposite directions in the circumferential direction. In two connection portions 50j, one located on one side θ1 in the circumferential direction extends from the lower end of the straight portion 50a to the other side θ2 in the circumferential direction, and the other located on the other side θ2 in the circumferential direction extends from the lower end of the straight portion 50a to one side θ1 in the circumferential direction. Each 12 hairpin conductors 52 are provided in the first conductor connection body 60A and the second conductor connection body 60B.

The first folded conductor 54 includes two straight portions 50b, 50c, two connection portions 50j, and one first folded portion (folded portion) 50f. The second folded conductor 55 includes two straight portions 50b, 50c, two connection portions 50j, and one second folded portion (folded portion) 50g. The first folded portion 50f and the second folded portion 50g are arranged at the upper end portion of the first folded conductor 54 or the second folded conductor 55.

The first folded portion 50f and the second folded portion 50g pass two straight portions 50b, 50c to each other. That is, in the first folded conductor 54 and the second folded conductor 55, the two straight portions 50b, 50c are connected to each other through the first folded portion 50f or the second folded portion 50g.

In the first folded conductor 54 and the second folded conductor 55, two connection portions 50j are bent in one side θ1 in the circumferential direction. That is, in the first folded conductor 54 and the second folded conductor 55, two connection portions 50j extend from the lower ends of the straight portions 50b, 50c to one side θ1 in the circumferential direction.

The first folded conductor 54 and the second folded conductor 55 have two straight portions 50b, 50c, respectively. In two straight portions 50b, 50c, one located on one side θ1 in the circumferential direction is the second straight portion 50b, and one located on the other side θ2 in the circumferential direction is the third straight portion 50c.

In the first folded conductor 54 and the second folded conductor 55, the distances between two straight portions 50b, 50c are different from each other. In the first folded conductor 54, the second straight portion 50b and the third straight portion 50c are arranged in the circumferential direction with the number of slots per pole s+1 (7 slots in the embodiment). On the other hand, in the second folded conductor 55, the second straight portion 50b and the third straight portion 50c are arranged in the circumferential direction with the number of slots per pole s−1 (5 slots in this embodiment). For this reason, the first folded portion 50f has a larger crossing amount in the circumferential direction by two slots than the second folded portion 50g. One first folded conductor 54 is provided in the first conductor connection body 60A. On the other hand, one second folded conductor 55 is provided in the second conductor connection body 60B.

Winding configurations of the first conductor connection body 60A and the second conductor connection body 60B will be described below.

In the first conductor connection body 60A, two end conductors 51 are arranged at both ends of the first conductor connection body 60A, and the first folded conductor 54 is arranged substantially in the middle. The first conductor connection body 60A is wave-wound every six slots toward the other side θ2 in the circumferential direction from the first end 63 to the first folded portion 50f. Furthermore, the first conductor connection body 60A is wave-wound every six slots toward one side θ1 in the circumferential direction from the first folded portion 50f to the second end 64.

At this point, in the first conductor connection body 60A, the region that is wave-wound on the other side θ2 in the circumferential direction between the first end 63 and the first folded portion 50f is referred to as a first portion 61. In the first conductor connection body 60A, the region that is wave-wound on one side θ1 in the circumferential direction between the first folded portion 50f and the second end 64 is referred to as a second portion 62. That is, the first conductor connection body 60A includes the first end 63, the first portion 61 wave-wound from the first end 63 to the other side θ2 in the circumferential direction, the first folded portion 50f connected to the end portion on the other end θ2 in the circumferential direction of the first portion 61, the second portion 62 wave-wound from the first folded portion 50f to one side θ1 in the circumferential direction, and the second end 64 connected to the end portion of one side θ1 in the circumferential direction of the second portion 62.

In the second conductor connection body 60B, two end conductors 51 are arranged at the ends of both ends of the second conductor connection body 60B. The second conductor connection body 60B in which the second folded conductor 55 is arranged substantially in the middle is wave-wound every six slots toward the other side θ2 in the circumferential direction from the first end 63 to the second folded portion 50g (first portion 61). Furthermore, the second conductor connection body 60B is wave-wound every six slots toward one side θ1 in the circumferential direction between (second portion 62) the second folded portion 50g and the second end 64. That is, the second conductor connection body 60B includes the first end 63, the first portion 61 wave-wound from the first end 63 to the other side θ2 in the circumferential direction, the second folded portion 50g connected to the end portion of the other side θ2 in the circumferential direction of the first portion 61, the second portion 62 wave-wound from the second folded portion 50g to one side θ1 in the circumferential direction, and the second end 64 connected to the end portion of one side θ1 in the circumferential direction of the second portion 62.

The conductor connection body 60 of the embodiment is wave-wound with the number of slots per pole s in the first portion 61 and the second portion 62. That is, the conductor connection body 60 is mounted on the stator core 20 by full pitch winding. For this reason, according to the embodiment, the plurality of conductors 50 arranged in the same slot S are all a part of the conductor connection body 60 having the same phase. Consequently, according to the embodiment, the conductor connection bodies 60 having different phases is not required to be insulated in one slot S, but the insulation is easy to secure.

In the embodiment, the winding portion 30 has the first end 63, the second end 64, the crossing portion 50d, and the folded portion 50f, 50g. The first end 63, the second end 64, the crossing portion 50d, and the folded portions 50f, 50g configure the coil end 30e on the upper side of the stator core 20. On the other hand, the connection portion 50j configures the coil end 30e on the lower side of the stator core 20. The first end 63 and the second end 64 are arranged on the outermost circumference of the coil end 30e. That is, the first end 63 and the second end 64 are located on the radial outside of the plurality of crossing portions 50d. The first end 63 extends upward (one side in the axial direction) from the stator core 20 and is connected to the phase bus bars 70, 80, 90. Similarly, the second end 64 extends upward (one side in the axial direction) from the stator core 20 and is connected to the neutral point bus bar 10. According to the embodiment, the first end 63 and the second end 64 are arranged on the outermost periphery of the coil end 30e, so that the bus bar unit 5 can be arranged on the radial outside of the coil end 30e. Thus, the dimensions in the vertical direction of the motor 1 can be reduced as compared with the case where the motor 1 is arranged above the coil end 30e.

According to the embodiment, the folded portions 50f, 50g are arranged on the innermost circumference of the coil end 30e. That is, the folded portions 50f, 50g are arranged on the radially inside of the plurality of crossing portions 50d. For this reason, the area radially inside the coil end 30e can be used as the arrangement area of the folded portions 50f, 50g, and the dimension in the vertical direction of the coil end 30e can be reduced.

Furthermore, according to the embodiment, the folded portions 50f, 50g are located on the innermost circumference of the coil end 30e, so that two ends 63, 64 can be located in the outermost circumference of the coil end 30e. That is, according to the embodiment, the first end 63 and the second end 64 extend from the outermost layer. Accordingly, a connection step between the neutral point bus bar 10 and the first end 63 and a connection step between the phase bus bars 70, 80, 90 and the second end 64 can be performed from the radial direction with respect to the coil end 30e, and a manufacturing process of the motor 1 can be simplified.

As illustrated in FIG. 4, the first conductor connection body 60A and the second conductor connection body 60B have opposite orders in the circumferential direction of the passing slots S at the folded portions 50f, 50g. The first end 63 of the first conductor connection body 60A is located on one side in the circumferential direction of the first end 63 of the second conductor connection body 60B. Furthermore, the second end 64 of the first conductor connection body 60A is located on the other side in the circumferential direction of the second end 64 of the second conductor connection body 60B. The U-phase connection body pair 69, the V-phase connection body pair 69, and the W-phase connection body pair 69 are arranged side by side in this order toward the other side θ2 in the circumferential direction.

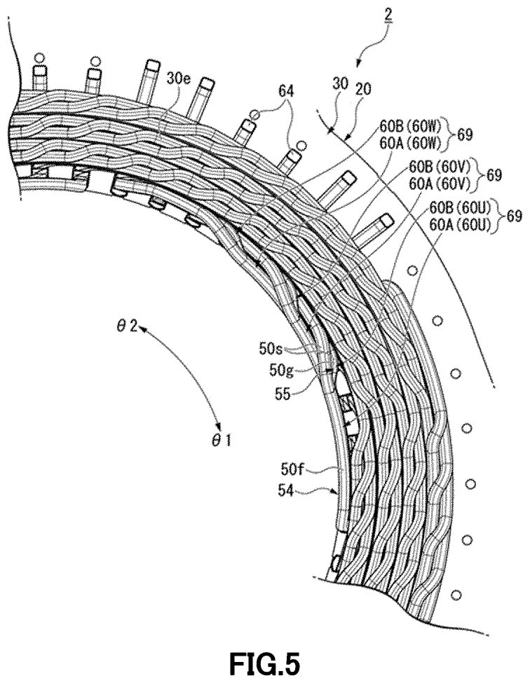

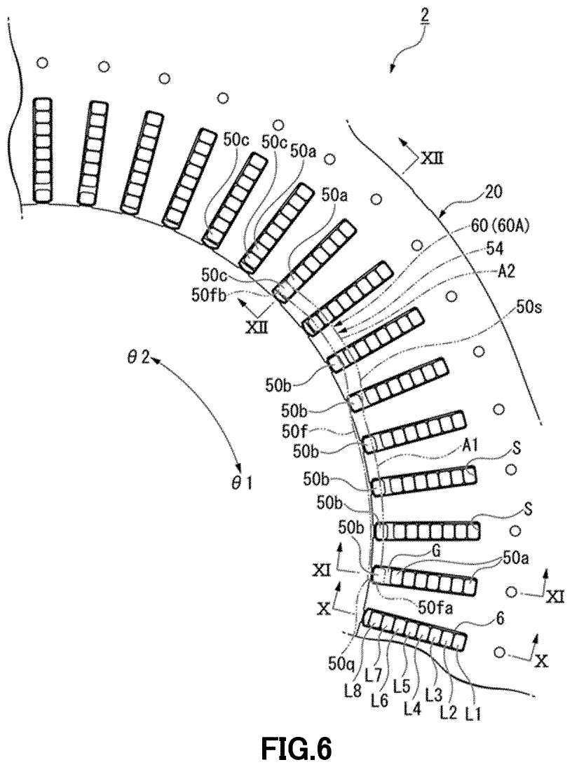

FIG. 5 is a plan view illustrating a part of the stator 2 of the embodiment. FIGS. 6, 7, and 8 are sectional views of the stator 2.

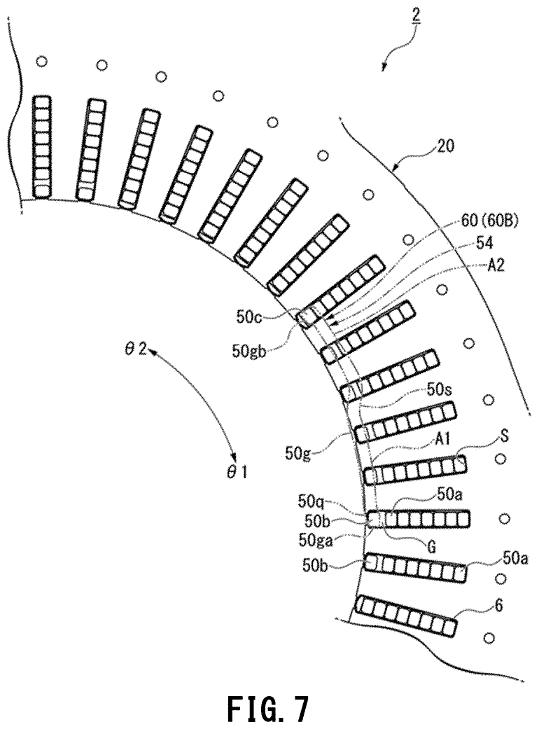

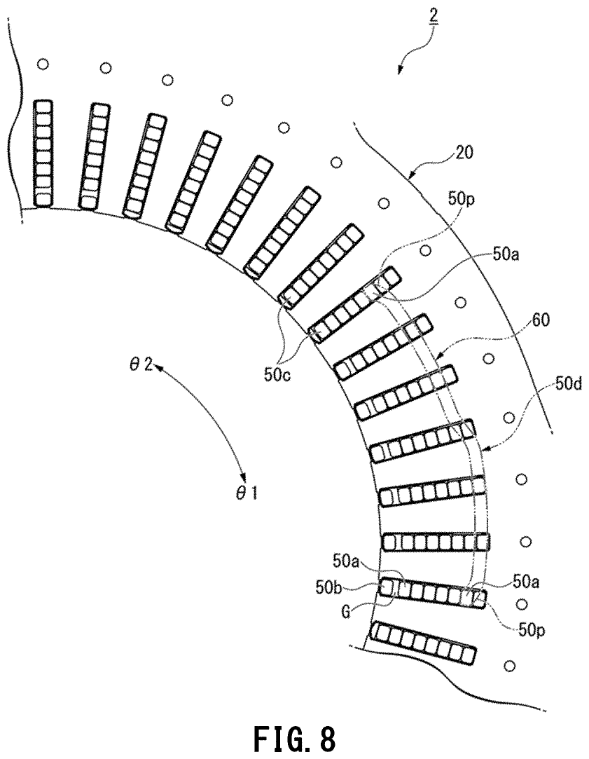

In addition, the same region of the stator 2 is enlarged and illustrated in FIGS. 5, 6, 7, and 8. The first folded portion 50f of the first folded conductor 54 is illustrated by a chain line in FIG. 6, the second folded portion 50g of the second folded conductor 55 is illustrated by a chain line in FIG. 7, and the crossing portion 50d of the hairpin conductor 52 is illustrated by a chain line in FIG. 8.

The first conductor connection body 60A including the first folded conductor 54 in FIG. 6 and the second conductor connection body 60B including the second folded conductor 55 in FIG. 7 configure the connection body pair 69 passing through the slots S adjacent to each other in the circumferential direction.

As illustrated in FIG. 6, the eight layers of one slot S are referred to as the first to eighth layers L1 to L8 from the outside to the inside in the radial direction. The first layer L1 is located in the outermost layer in the slot S. In the embodiment, the straight portion 50a arranged in the first layer L1 contacts with the inner peripheral surface of the core back 21 through the insulating paper 6. The eighth layer L8 is located in the innermost layer of the slot S. The straight portions 50a, 50b, 50c arranged on the eighth layer L8 is opposed to the opening 29h of the slot S in the radial direction.

As illustrated in FIG. 8, two first straight portions 50a connected to the crossing portion 50d pass through the slots S separated by the number of slots per pole s (six in the embodiment) in the circumferential direction. That is, the conductor connection body 60 extends between the slots S separated by s at the crossing portion 50d.

As illustrated in FIG. 6, the second straight portion 50b and the third straight portion 50c connected to the first folded portion 50f pass through the slots S separated by the number of slots per pole s+1 in the circumferential direction (seven in the embodiment).

As illustrated in FIG. 7, the second straight portion 50b and the third straight portion 50c connected to the second folded portion 50g pass through the slots S separated by the number of slots per pole s−1 in the circumferential direction (five in the present embodiment).

Two in-phase conductor connection bodies 60 (the first conductor connection body 60A and the second conductor connection body 60B) pass through the slots S adjacent to each other in the circumferential direction. The second conductor connection body 60B that is one of the two conductor connection bodies 60 extends between the slots S separated by s−1 at the second folded portion 50g. The first conductor connection body 60A that is the other of the two conductor connection body 60 extends between the slots S separated by s+1 at the first folded portion 50f.

As illustrated in FIGS. 6, 7, and 8, the straight portions 50a arranged in the second layer L2 to the eighth layer L8 in the slot S exist all the first straight portions 50a. The first straight portion 50a can be arranged in all of the first to eighth layers L1 to L8. On the other hand, the second straight portion 50b and the third straight portion 50c are arranged only in the eighth layer L8.

The first straight portion 50a is arranged in the slot S so as to be close to the radial outside. That is, the first straight portion 50a contacts with the straight portion 50a arranged outside the slot S. For example, the first straight portion 50a arranged in the second layer L2 of one slot S comes into contact with the first straight portion 50a arranged in the first layer L1 of the same slot S. The first straight portion 50a arranged in the eighth layer L8 of one slot S comes into contact with the first straight portion 50a arranged in the seventh layer L7 of the same slot S. This relationship with the straight portion of the outer layer applies to the first straight portions 50a arranged in all layers.

Similarly, the third straight portion 50c is arranged so as to be close to the radial outside in the slot S. Because the third straight portion 50c is arranged in the eighth layer L8 of the slot S, the third straight portion 50c comes into contact with the first straight portion 50a arranged in the seventh layer L7 of the same slot S.

On the other hand, in the second straight portion 50b, a gap G is provided between the second straight portion 50b and the straight portion 50a arranged outside the slot S. Because the second straight portion 50b is arranged in the eighth layer L8 of the slot S, the gap G is provided between the second straight portion 50b and the first straight portion 50a arranged in the seventh layer L7 of the same slot S.

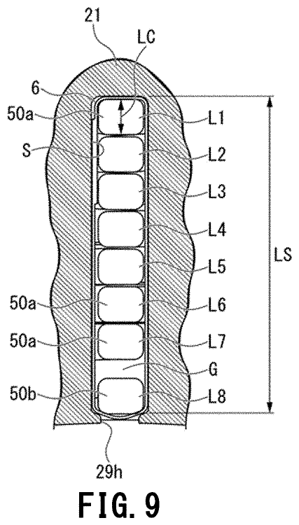

FIG. 9 is a sectional view illustrating the slot S in which the second straight portion 50b is arranged.

As illustrated in FIG. 9, the radial dimension of the slot S is set to LS. The radial dimension of the section of the straight portions 50a, 50b, 50c arranged in the slot S is set to LC. The number of linear portions arranged in the radial direction in one slot S is set to N (eight in the embodiment). Also, n is set to a constant. Sectional shapes and dimensions of the first straight portion 50a, the second straight portion 50b, and the third straight portion 50c are the same.

In this case, the following equation holds.

LS=LC×(N+n)

0<n≤1

The above equation means that the radial dimension LS of the slot S is larger than the radial dimension of eight straight sections and less than or equal to the radial dimension of nine straight sections. Accordingly, when eight straight portions are arranged along the radial direction in the slot S, the gap G smaller than or equal to the radial dimension of one straight portion is provided.

In the embodiment, the first straight portions 50a come into contact with each other. In the slot S in which the second straight portion 50b is arranged, the first straight portion 50a arranged in the first layer L1 contacts with the inner peripheral surface of the core back 21 through the insulating paper 6. For this reason, a space corresponding to the dimension of the straight portion more than one and greater than or equal to two is provided between the first straight portion 50a of the seventh layer L7 and the opening 29h of the slot S. In the embodiment, the second straight portion 50b is unevenly arranged toward the opening 29h in the slot S. For this reason, the gap G corresponding to the dimension of one or less straight portions is provided between the second straight portion 50b and the first straight portion 50a outside the second straight portion 50b.

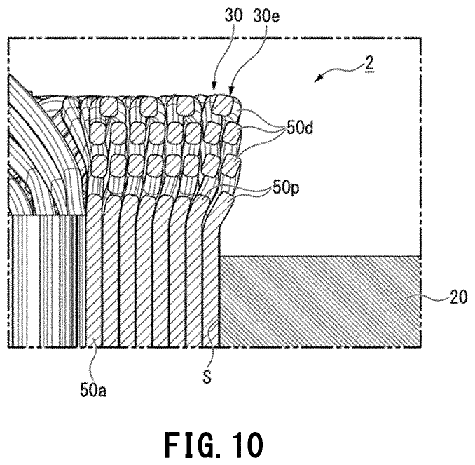

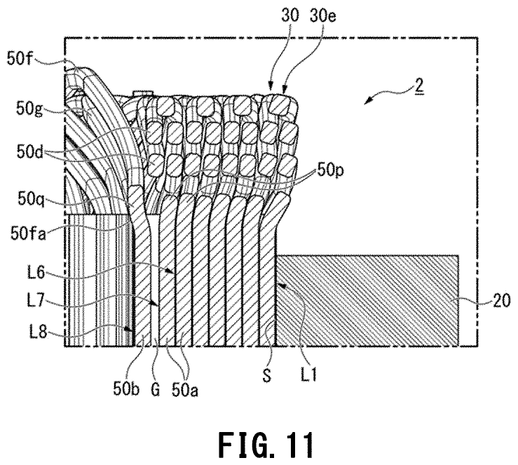

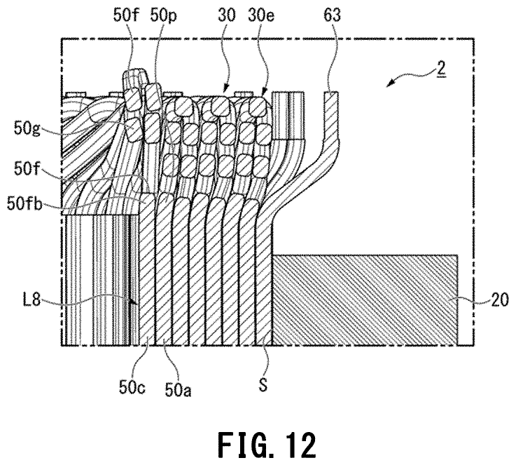

FIG. 10 is a sectional view of the stator 2 along a line X-X of FIG. 6. FIG. 11 is a sectional view of the stator 2 along a line XI-XI of FIG. 6. FIG. 12 is a sectional view of the stator 2 along a line XII-XII of FIG. 6.

The first straight portion 50a is arranged in all of the first to eighth layers L1 to L8 of the slots S through which the sectional line in FIG. 10 passes. As illustrated in FIG. 10, the crossing portion 50d is inclined radially outside with respect to the first straight portion 50a and extends upward. As described above, the crossing portion 50d has an outside extension portion 50p that is inclined radially outside in the region extending from the first straight portion 50a. As illustrated in FIG. 8, the crossing portion 50d has the outside extension portion 50p at the end portion of one side θ1 in the circumferential direction and the end portion of other side θ2 in the circumferential direction. For this reason, the crossing portion 50d extends so as to bypass the radial outside while straddling the slots S.

The first straight portion 50a is arranged in the first to seventh layers L1 to L7 of the slots S through which the sectional line in FIG. 11 passes, and the second straight portion 50b is arranged in the eighth layer L8. In the slot S, the gap G between the first straight portion 50a and the second straight portion 50b extends uniformly along the vertical direction. Even in the slot S through which the sectional line in FIG. 11 passes, the crossing portion 50d projects radially outside with respect to the first straight portion 50a. That is, all the crossing portions 50d have the outside extension portion 50p that is inclined radially outside in a region extending from the first straight portion 50a.

As illustrated in FIG. 11, the first folded portion 50f is inclined radially inside with respect to the second straight portion 50b and extends upward. As described above, the first folded portion 50f includes the inside extension portion 50q that is inclined radially inside in the region extending from the second straight portion 50b. As illustrated in FIG. 6, the first folded portion 50f includes the inside extension portion 50q at the end portion of one side θ1 in the circumferential direction. For this reason, the first folded portion 50f extends so as to bypass the radial outside while straddling the slots S.

The first straight portion 50a is arranged in the first to seventh layers L1 to L7 of the slot S through which the sectional line in FIG. 12 passes, and the third straight portion 50c is arranged in the eighth layer L8. As illustrated in FIG. 12, the extending direction of the first folded portion 50f with respect to the third straight portion 50c does not incline in the radial direction. That is, the first folded portion 50f extends directly above the third straight portion 50c.

As illustrated in FIG. 6, the first folded portion 50f includes a bent portion 50s. The bent portion 50s is arranged between one end 50fa located on one side θ1 in the circumferential direction of the first folded portion 50f and the other end 50fb located on the other side θ2 in the circumferential direction. The bent portion 50s is bent radially outside from one end 50fa toward the other end 50fb.

One end 50fa of the first folded portion 50f extends radially inside from the second straight portion 50b at the inside extension portion 50q. On the other hand, the other end 50fb of the first folded portion 50f extends directly above from the third straight portion 50c. The first folded portion 50f includes a first region A1 that extends from the inside extension portion 50q located at one end 50fa to the bent portion 50s while bypassing on the radial inside. Furthermore, the first folded portion 50f includes a second region A2 that passes through the radial outside of the first region A1 from the bent portion 50s toward the side of the other end 50fb.

According to the embodiment, the gap G is provided between the second straight portion 50b and the first straight portion 50a outside the second straight portion 50b in the slot S. Consequently, one end 50fa of the first folded portion 50f connected to the second straight portion 50b can be arranged so as to be biased radially inside.

In the embodiment, in the slot S, the first straight portions 50a are in contact with each other, and the radial gap G is provided between the second straight portion 50b and the first straight portion 50a outside the second straight portion 50b. However, the first straight portions 50a may be separated from each other, such as when inclusions are arranged between the straight portions 50a, 50b, 50c in the slot S. Even in this case, the first folded portion 50f can be retracted radially inside by increasing the distance between the second straight portion 50b and the first straight portion 50a outside the second straight portion 50b with respect to the distance between the first straight portions 50a. That is, the above effect can be obtained when the distance between the second straight portion 50b and the first straight portion 50a located outside the second straight portion 50b in the slot S is larger than the distance between the first straight portions 50a.

According to the embodiment, the first folded portion 50f extends radially inside from the second straight portion 50b at one end 50fa, and thus passes through a path biased further inside. That is, the protrusion direction of the first folded portion 50f with respect to the second straight portion 50b is inside in the radial direction, and the protrusion direction of the crossing portion 50d with respect to the first straight portion 50a is outside in the radial direction. Accordingly, the first folded portion 50f can be arranged while biased radially inside and the crossing portion 50d can be arranged while biased radially outside, so that the first folded portion 50f and the crossing portion 50d can be separated from each other.

The radial protrusion direction of the first folded portion 50f and the radial protrusion direction of the crossing portion 50d are not limited to the embodiment. For example, the protrusion direction of the first folded portion 50f with respect to the second straight portion 50b may be the radial inside, and the protrusion direction of the crossing portion 50d with respect to the first straight portion 50a may not be inclined in any of the radial direction. The protrusion direction of the first folded portion 50f with respect to the second straight portion 50b may not be inclined in any of the radial direction, and the protrusion direction of the crossing portion 50d with respect to the first straight portion 50a may be the radial outside. In this way, the protrusion direction of the first folded portion 50f and the protrusion direction of the crossing portion 50d may be different from each other such that the distance between the first folded portion 50f and the crossing portion 50d can be separated from each other. That is, the above effect can be obtained when the radial protrusion direction of the first folded portion 50f with respect to the second straight portion 50b and the radial protrusion direction of the crossing portion 50d with respect to the first straight portion 50a are different from each other.

As described above, according to the embodiment, the second straight portion 50b connected to the first folded portion 50f is separated from the first straight portion 50a on the outside of the second straight portion 50b, and the first folded portion 50f is arranged radially inside by providing the inside extension portion 50q at one end 50fa of the first folded portion 50f. Accordingly, the first folded portion 50f can be arranged radially inside from the crossing portion 50d arranged on the outside of the first folded portion 50f.

As illustrated in FIG. 7, similarly to the first folded portion 50f, the second folded portion 50g includes the inside extension portion 50q at one end 50ga of one side θ1 in the circumferential direction. The second folded portion 50g includes the bent portion 50s that is bent on the radial outside from one end 50ga toward the side of the other end 50gb. Similarly to the first folded portion 50f, the second folded portion 50g includes the first region A1 that extends radially inward from the inside extension portion 50q located at one end 50ga to the bent portion 50s while bypassing on the radial inside. The second folded portion 50g includes the second region A2 that passes through the radial outside of the first region A1 from the bent portion 50s toward the side of the other end 50gb.

According to the embodiment, the second straight portion 50b connected to the second folded portion 50g is separated from the first straight portion 50a on the outside of the second straight portion 50b, and the inside extension portion 50q is provided at one end 50ga of the second folded portion 50g, so that the second folded portion 50g is arranged radially inside. Accordingly, the second folded portion 50g can be arranged radially inside from the crossing portion 50d arranged on the outside of the second folded portion 50g.

Two conductor connection bodies 60 having the first folded portion 50f and the second folded portion 50g constitute the connection body pair 69. The connection body pairs 69 having different phases are arranged adjacent to each other in the circumferential direction. For this reason, as illustrated in FIG. 5, the folded portions 50f, 50g of the conductor connection bodies 60 having different phases are arranged adjacent to each other in the circumferential direction. According to the embodiment, the second folded portion 50g includes the bent portion 50s, so that interference with the folded portions 50g, 50g of other adjacent phases is prevented.

As illustrated in FIGS. 6 and 7, the second straight portion 50b is separated from the first straight portion 50a located outside the second straight portion 50b in the slot S, while the third straight portion 50c is in contact with the first straight portion 50a located outside the third straight portion 50c in the slot S. That is, in the slot S, the distance between the second straight portion 50b and the first straight portion 50a located outside the second straight portion 50b is larger than the distance between the third straight portion 50c and the first straight portion 50a located outside the third straight portion 50c. Furthermore, the second straight portion 50b and the third straight portion 50c are connected to both ends of the folded portions 50f, 50g. For this reason, the radial positions at one end and the other end of the folded portions 50f, 50g are deviated from each other. According to the embodiment, the radial positions of one end and the other end of the folded portions 50f, 50g are displaced from each other, so that the bent portion 50s can be provided between one end and the other end of the folded portions 50f, 50g.

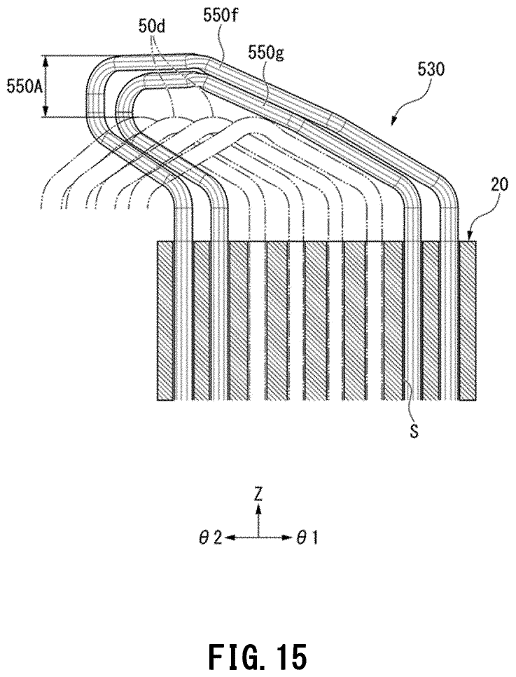

FIG. 15 is a schematic view illustrating a first folded portion 550f and a second folded portion 550g of a comparative embodiment as a conventional structure.

A winding portion 530 of the comparative embodiment has the same winding configuration as that of the embodiment, but configurations of a first folded portion 550f and the second folded portion 550g are different. The first folded portion 550f and the second folded portion 550g of the comparative embodiment cannot be retracted radially inside with respect to the crossing portion 50d. For this reason, the folded portions 550f, 550g of the comparative embodiment have a retracted region 550A protruding above the crossing portion 50d, above the upper end portion of the crossing portion 50d.

The folded portions 550f, 550g of the comparative embodiment extend along an inclination direction of the crossing portion 50d in order to prevent the interference with the crossing portion 50d in the region below the retracted region 550A. The crossing portion 50d is inclined to the other side θ2 in the circumferential direction toward the upper side. For this reason, the folded portions 550g, 550f have a hairpin shape that makes a U-turn from the other side θ2 in the circumferential direction to the one side θ1 in the circumferential direction in the retracted region 550A. As described above, the folded portions 550f, 550g of the comparative embodiment have a large protrusion height with respect to the crossing portion 50d of the retracted region 550A.

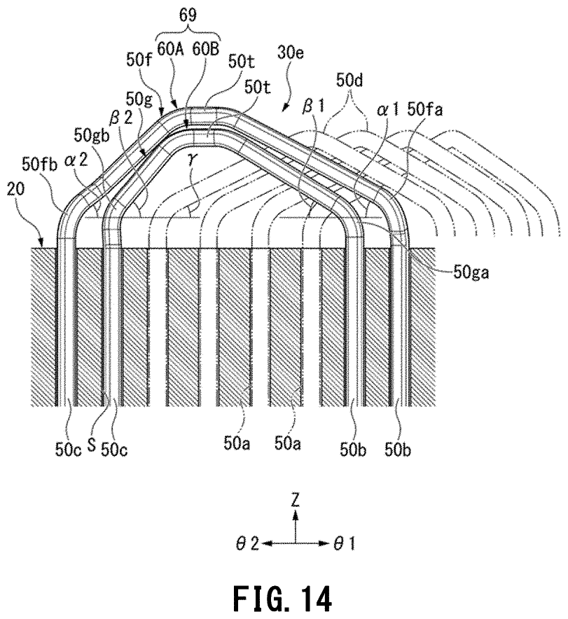

FIG. 14 is a schematic view illustrating the first folded portion 50f and the second folded portion 50g of the embodiment.

As described above, in the first conductor connection body 60A, the wave-wound direction is folded from the other side θ2 in the circumferential direction to one side θ1 in the circumferential direction at the first folded portion 50f. Similarly, in the second conductor connection body 60B, the wave-wound direction is folded back from the other side θ2 in the circumferential direction to one side θ1 in the circumferential direction at the second folded portion 50g.

The first folded portion 50f and the second folded portion 50g are arranged so as to be retracted radially inside with respect to another crossing portions 50d. For this reason, the first folded portion 50f and the second folded portion 50g straddle between the slots S without interfering with another crossing portions 50d.

However, the radial positions of the first folded portion 50f and the second folded portion 50g are matched with each other. At this point, the first folded portion 50f straddles the seven (the number of slots per pole s+1) slots S, and the second folded portion 50g straddles the five (number of slots per pole s−1) slots S. Furthermore, two slots S from which the first folded portion 50f extends are arranged circumferentially outside with respect to two slots S from which the second folded portion 50g extends.

In the embodiment, the first folded portion 50f passes above the second folded portion 50g. The first folded portion 50f is arranged so as to straddle the second folded portion 50g from the upper side and both sides in the circumferential direction. Further, four slots S are arranged between two extending slots S of the second folded portion 50g. The first folded portion 50f and the second folded portion 50g are arranged so as to overlap each other when viewed from above. For this reason, the arrangement spaces of the first folded portion 50f and the second folded portion 50g can be reduced, and the radial dimension of the coil end 30e can be reduced.

The folded portions 50f, 50g of the embodiment extends while being inclined downward from an upper end portion 50t (the end portion on one side in the axial direction) toward both sides in the circumferential direction. In the first folded portion 50f, a first inclination angle α1 toward one side θ1 in the circumferential direction and a second inclination angle α2 toward the other side θ2 in the circumferential direction from the upper end portion 50t are different from each other. Similarly, in the second folded portion 50g, a first inclination angle β1 toward one side θ1 in the circumferential direction and a second inclination angle β2 toward the other side θ2 in the circumferential direction from the upper end portion 50t are different from each other. Furthermore, the first inclination angles α1, β1 and the second inclination angles α2, β2 are different from an inclination angle γ of the protrusion direction in the circumferential direction of the crossing portion 50d with respect to the first straight portion 50a of the crossing portion 50d. That is, according to the embodiment, the protrusion directions in the circumferential direction of the folded portions 50f, 50g with respect to the straight portions 50b, 50c and the protrusion directions in the circumferential direction of the crossing portion 50d with respect to the first straight portion 50a are different from each other.

At this point, the inclination angles α1, α2, β1, β2, γ are inclination angles with respect to the straight portion of the region connected to the straight portion.

According to the folded portions 50f, 50g of the embodiment, the inclination angles α1, α2, β1 β2 of each region can be set to the angle different from the inclination angle γ of the crossing portion 50d in order to retract the folded portions 50f, 50g radially inside with respect to the crossing portion 50d. That is, according to the embodiment, the folded portions 50f, 50g are retracted radially inside with respect to the crossing portion 50d arranged on the outside of the folded portions 50f, 50g, so that a part of the coil end 30e can be prevented from protruding upward. This leads to the reduced size in the axial direction of the motor 1.

As described with reference to FIG. 9, in the slot S and the straight portions 50a, 50b, 50c of the embodiment, the dimensions LS, LC, the number N, and the constant n have the following relations, so that the gap G can be provided between the second straight portion 50b and the first straight portion 50a.

LS=LC×(N+n)

0<n≤1

More preferable the following equation holds for the above constant n.

0<n≤0.3

When the relationship holds in the dimensions LS, LC, the number N, and the constant n, the folded portions 50f, 50g can be retracted radially inside from the crossing portion 50d while the gap between the second straight portion 50b and the first straight portion 50a is minimized. For this reason, the radial dimension of the slot S does not become too large, and the radial dimension of the motor 1 can be miniaturized.

As described above, the conductor connection body 60 of the embodiment is 4Y-connected, and the number N of the straight portions 50a, 50b, 50c arranged in the radial direction in the slot S is eight. However, when the number N of the straight portions 50a, 50b, 50c arranged in the radial direction in the slot S is a multiple of 4, the configuration of the embodiment can be adopted in the 4Y-connected winding portion 30.

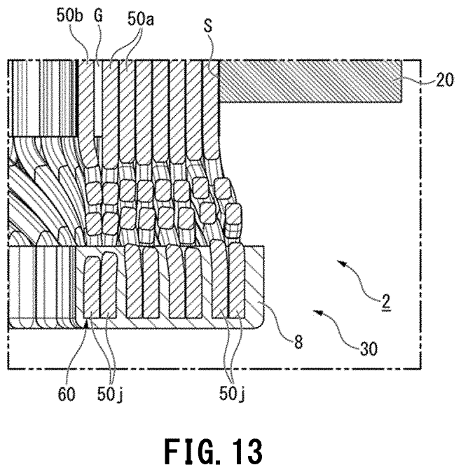

FIG. 13 is a sectional view illustrating the lower end portion of the slot S through which the sectional line in FIG. 11 passes.

The conductor connection body 60 includes the connection portion 50j that connects the straight portions 50a, 50b, 50c to each other on the other side in the axial direction of the stator core 20. The connection portions 50j are joined to each other using joining means such as resistance welding. Furthermore, the joining portion of the connection portion 50j is covered with an insulating covering member 8.

In the embodiment, the protrusion direction of the connection portion 50j connected to the second straight portion 50b with respect to the second straight portion 50b is outside in the radial direction. As described above, the second straight portion 50b is arranged while the gap G is provided between the second straight portion 50b and the first straight portion 50a arranged outside the second straight portion 50b. Furthermore, the connection portion 50j connected to the second straight portion 50b is connected to the connection portion 50j connected to the first straight portion 50a. For this reason, the connection portion 50j can be easily joined to another connection portion 50j by extending the connection portion 50j connected to the second straight portion 50b to the radial outside.

Although the embodiment of the present invention is described above, structures in the embodiment are examples, and thus addition, elimination, replacement of structure, and other modifications can be made within a range without departing from the spirit of the present invention. Also note that the present invention is not limited by the embodiment.

For example, in the embodiment, the case where the motor 1 is the three-phase motor has been described. However, the motor 1 may be another motor such as a five-phase motor.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A motor comprising:
a rotor that is rotatable around a center axis line; and
a stator that is disposed on a radial outside of the rotor,
wherein
the stator includes:
a stator core in which a plurality of slots standing in a circumferential direction are provided; and
a plurality of conductor connection bodies in which a plurality of conductors are connected in series, the plurality of conductor being inserted into the plurality of slots,
each of the conductor connection bodies includes:
a first end located on an outermost circumference in a radial direction;
a first portion that is wave-wound from the first end to the other side in the circumferential direction;
a folded portion that is located on an innermost circumference in the radial direction and on one side in the axial direction of the stator core and connected to an end portion on the other side in the circumferential direction of the first portion;
a second portion that is wave-wound from the folded portion to one side in the circumferential direction; and
a second end that is located on the outermost circumference in the radial direction and connected to an end portion on one side in the circumferential direction of the second portion,
each of the first portion and the second portion includes:
a plurality of straight portions that extend along the axial direction and are located in the slot; and
a crossing portion that connects the straight portions to each other on one side in the axial direction of the stator core,
the following expressions hold,
LS=LC×(N+n)
0<n≤1
where, a radial dimension of the slot is LS, a radial dimension of a section of the straight portion disposed in the slot is LC, and a number of the straight portions standing in the radial direction in one slot is N, and n is a constant,
the plurality of straight portions include:
a first straight portion connected to the crossing portion: and
a second straight portion that is connected to an end of the folded portion and disposed in an innermost layer in the slot,
in the slot, a distance between the second straight portion and the first straight portion located outside the second straight portion is larger than a distance between the first straight portions, and
a protrusion direction in the radial direction of the folded portion with respect to the second straight portion and a protrusion direction in the radial direction of the crossing portion with respect to the first straight portion are different from each other.

2. The motor according to claim 1, wherein
the protrusion direction of the folded portion with respect to the second straight portion is inside in the radial direction, and
the protrusion direction of the crossing portion with respect to the first straight portion is outside in the radial direction.

3. The motor according to claim 1, wherein the protrusion direction in the circumferential direction of the folded portion with respect to the straight portion and the protrusion direction in the circumferential direction of the crossing portion with respect to the first straight portion are different from each other.

4. The motor according to claim 1, wherein
the plurality of conductor connection bodies are connected in Y-connection of 2×M with M as a natural number,
each of the conductor connection bodies extends between the slots separated by s at the crossing portion,
the two in-phase conductor connection bodies pass through the slots adjacent to each other in the circumferential direction, one of the conductor connection bodies extends between the slots separated by s−1 at the folded portion, and the other conductor connection body extends between the slots separated by s+1 at the folded portion and passes above the folded portion of the one of the conductor connection bodies.

5. The motor according to claim 4, wherein
the folded portions of the conductor connection bodies having different phases are disposed adjacent to each other in the circumferential direction, and
the folded portion includes a bent portion that is bent radially outside from the side of one end toward the side of the other end.

6. The motor according to claim 5, wherein
the plurality of straight portions include a third straight portion that is connected to the other end of the folded portion and is disposed in the innermost layer of the slots,
a distance between the second straight portion and the first straight portion located outside the second straight portion is larger than a distance between the third straight portion and the first straight portion located outside the third straight portion in the slot.

7. The motor according to claim 1, wherein an expression 0<n≤0.3 holds for the constant n.

8. The motor according to claim 1, wherein
a number N of the straight portions standing in the radial direction in one slot is a multiple of 4, and
the plurality of conductor connection bodies are 4Y-connected.

9. The motor according to claim 1, wherein
the conductor connection body includes a connection portion that connects the straight portions to each other on the other side in the axial direction of the stator core, and
the protrusion direction of the connection portion connected to the second straight portion with respect to the second straight portion is outside in the radial direction.
